(19) United States
(12) Patent Application Publication
(10) Pub. No.: US 2024/0165743 A1
(43) Pub. Date: May 23, 2024

(54) Method For Laser Welding

(71) Applicant: Kirchhoff Automotice Deutschland GmbH, Attendorn (DE)

(72) Inventors: Jan STUHRMANN, Drolshagen (DE); Christian DAHMEN, Olpe (DE)

(21) Appl. No.: 18/551,027

(22) PCT Filed: Mar. 22, 2022
(86) PCT No.: PCT/EP2022/057402

§ 371 Date: Sep. 18, 2023

(30) Foreign Application Priority Data
Mar. 22, 2021 (DE) 10 2021 107 058.9

(51) Int. Cl. B23K 26/244; B23K 26/242

(52) U.S. Cl. CPC B23K 26/244; B23K 26/242

(57) ABSTRACT

A method is described for laser welding two joining partners (1d, 2d) made of a metal material and held together in a lap joint, wherein the first joining partner (1d) includes a joining flange (3) having a joint and the second joining partner (2d) includes a joining zone (6d) on a flat side, wherein for the process of laser welding, the first joining partner (1d) is held contacting the joining zone (6d) of the second joining partner (2d) with one side of its joining flange (3d), wherein between the two joining partners (1d, 2d), a gap (10d) widening in the direction pointing away from the side to which the laser is applied is provided and the laser beam (7) is directed in the fillet formed by joining zone (6d) and joining flange (3d) at an angle α of 1° to 45° in relation to the plane of the joining zone 6d and the welding is carried out so that the weld seam (12) formed extends into the gap 10d and in this way in the gap (10d) a gap base SB is formed, by which the opposing surfaces of the joining partners (1d, 2d) are spaced apart.

The invention relates to a method for laser welding having the features of the preamble of claim 1.

Laser welding is a common method for materially bonding two joining partners to one another. Here, the two joining partners are positioned relative to one another and typically held together using a clamping device. The joint is then melted by means of a laser beam to materially bond the two joining partners. Laser welding has the advantage that, although sufficiently high energy is locally introduced into the workpieces, the heat-influence zone remains small, since only little material is melted due to the high welding speed and the energy introduced only very locally. To carry out the welding process, the laser head is moved with the laser beam relative to the joining partners held together. The laser head is typically moved while the joining partners remain stationary.

A laser welding method is disclosed, for example, in DE 10 2017 105 900 A1. In this previously known method, the two joining partners are connected to one another at their joints in that the two joining partners are aligned in such a way that their joining flanges abut one another and their joints end flush with one another. For welding, a laser beam is directed onto the joint gap between the two joining flanges and thus onto the joints. The two joining partners are positioned at an angle in relation to one another so that there is a gap on the side facing away from the laser beam, from which the degassing products, which arise primarily when welding coated joining partners, such as galvanized sheet steel, can be discharged without this degassing process having a disadvantageous effect on the formation of the weld seam.

A method for connecting two steel sheets is known from EP 0 771 605 B1, wherein at least one of these steel sheets includes a coating having a low melting point, for example a zinc coating. According to this previously known method, the two joining partners are arranged to abut one another at an acute angle for the purpose of joining. A fillet weld is then formed as the weld seam and in this way one of the metal sheets is welded to the other along its end face. Welding takes place by means of a laser beam. A laser beam fillet weld is placed by this laser beam along the joint of one joining partner. The two joining partners are positioned and held in relation to one another in a clamping device for the purpose of joining. In order to effectuate degassing through the gap formed by the angled arrangement of the two joining partners relative to one another, the cut edge of one joining partner is equipped with teeth along its end face. The degassing products of the coating can then escape through the gaps located between the teeth and the degassing pathway provided by the angled arrangement of the joining partners on the side facing away from the laser beam. Due to the design of the weld seam as a fillet weld, it does not penetrate the joint. The gap on the side facing away from the weld, which can have an opening angle of 7° to 15° , ends with a zero gap width at the weld seam.

The problem here is that such an angled arrangement of components can result in signs of corrosion in the region of the root of the gap located on the side facing away from the laser beam. Due to the increasing demands for corrosion resistance, even small corrosion points that can occur over the service life of such a component are no longer accepted. This can occur with the above-mentioned method because the zinc coating vaporizes and is removed in the area of the welding point. The gap formed by the angled positioning of the two joining partners in relation to one another is usually not wide enough or the gap angle is too small for the desired coatings to be able to be introduced into those areas in which the zinc coating has vaporized due to the welding process. Coatings are possible, such as wax coatings for cavity preservation or another suitable zinc coating; however, these are associated with increased effort and accompanying higher costs.

Against this background, it is the object of the invention to propose a laser welding method, using which two components (joining partners) can be securely connected and in which the corrosion problem described above is avoided.

This object is achieved using a generic method mentioned at the outset, which is characterized in that the first joining partner includes a joining flange with a joint and the second joining partner includes a joining zone on a flat side, wherein for the process of laser welding, the first joining partner is held with a side of its joining flange contacting the joining zone of the second joining partner, wherein a gap widening in the direction pointing away from the side subjected to the laser is provided between the joining partners, and wherein the laser beam is directed into the fillet formed by joining zone and joining flange at an angle of 1° to 45° in relation to the plane of the joining zone and carries out the welding so that the weld seam formed extends into the gap and in this way a gap base is formed in the gap, by which the mutually opposing surfaces of the joining partners are spaced apart.

Preferred refinements are described in the dependent claims.

Surprisingly, it has been shown that positioning the laser beam opposite to the joining zone in the case of a lap joint weld does not have the result that the second joining partner is not deeply welded or welded through in the region of its joining zone, but rather in the contact and gap area—the joint—the two joining partners form an astoundingly homogeneous and deep weld root, which is curved in the direction of the gap opening and does not linearly follow the angle of light incidence. The welding depth extends through the actual joint into the gap on the side facing away from the laser beam. Molten metal penetrates into the gap and fills the narrowest area of the gap. The melt flowing into the gap on the side facing away from the laser forms a floor, by which the lateral surfaces of the joining partners delimiting the gap are spaced apart. Such a gap base can be embodied as straight, more or less straight, or convex or also concave. It is essential that the gap width of the gap located between the joining partners on the side facing away from the laser beam does not have a zero extent at any point due to the gap base or is so narrow that the desired corrosion coating cannot reach it. The laser welding process is carried out in a controlled manner—even without welding allowance—by which the gap is filled by molten material up to such a gap width through the base formed by the melt, until the gap width is sufficiently large that it ensured for a subsequent coating process, for example a CDC coating, that this material reaches the root of the gap, which in this method is formed by the gap base formed by the welding process. As a rule, a gap width of approximately 0.2 mm is considered sufficient to meet this requirement. Such a width is sufficient so that the entire component can be coated in a cost-effective manner, for example using a CDC coating (CDC=cathodic dip coating). By filling the root of the gap on the side facing away from the laser beam up to a gap width into which CDC coating can be deposited, it is ensured that a CDC coating can also be applied as intended in these areas of the component.

The heat introduced into the joint of the joining flange of the first joining partner by the laser beam melts it in sections, as a result of which the melt brought into the gap by the joint is provided. The second joining partner functions as a weld seam support with its joining zone. Because the laser beam is incident on this joining surface at an angle that is preferably less than 45°, in particular less than 30°, the energy introduced into the joining zone of the second joining partner is significantly lower than that introduced into the joint of the first joining partner. The joint of the first joining partner is thus used as a source for welding material. Using the joint of the joining flange of the first joining partner as a source or reservoir for the welding material has the advantage that the laser beam is applied to the first joining partner at least significantly into the joint and thus in the direction of the material extension and not transversely thereto. This is advantageous for the welding process, as there is then no risk of this joining partner being burned through. For this purpose, the geometric center line of the laser beam is offset from the joint, which is formed by the adjoining of the two joining partners, preferably in the direction toward the first joining partner.

The joint of the joining flange of the first joining partner is typically linear in the direction of its extension in material thickness.

The joining flange can be angled relative to the main extension of the joining partner; in particular, it can be a flared, perhaps folded collar. The transition between the joining flange and the other components of this joining partner is then typically curved with a radius due to the forming process. In such an embodiment, the one wall delimiting the gap is curved with a successively increasing opening angle.

The second joining partner, on the other hand, has a flat joining zone onto which the joining flange of the first joining partner is welded. The joining zone is typically distinguishable from the joint of the joining partner. This joining zone is typically spaced apart from the end of the joining partner with respect to its side to which the laser beam is appplied. However, this joining zone can also be located in any desired area of this joining partner.

For the process of laser welding, the joining flange of one joining partner is brought up to the joining zone of the other joining partner, so that both joining partners contact each other to form the joint. The joining flange of the first joining partner is set back in relation to the end of the second joining partner, so that a fillet is formed. The goal is to position the two joining partners in relation to one another with a so-called zero gap in the joint. The contact between the two joining partners can be in the form of a line or a surface. If the joining flange and the joining zone lie flat against one another, care should be taken to ensure that the extension of this surface in the direction of the depth of the joint is not greater than the material thickness of the thinner joining partner. Investigations have shown that otherwise the desired weld seam formation with its extension into the gap cannot be brought about with the provided laser beam energy. Ideally, the first joining partner is the joining partner that is thinner in the joining zone. With this configuration, a high-strength connection could be achieved in a particularly process-reliable manner while at the same time filling the root of the set gap on the side of the joint facing away from the laser beam, so that the gap width in the area of the root is at least 0.2 mm wide.

If the joining flange of the first joining partner is angled in relation to adjacent areas, the gap results automatically from the curvature of the joining partner caused by the offset. If both joining partners are flat, it is necessary for the joining flange to be held at an angle of 5° to 45° to the joining zone in order to ensure sufficient expansion. It is apparent that the gap angle is selected in such a way that the gap can be filled with the available melt until the minimum gap width provided is large enough for an anti-corrosion coating to be able to be deposited easily. Any degassing products can escape through the established gap, in particular if the joining partners are zinc coated. At the same time, the gap is a guideline for the weld root; this extends along the gap and thus connects the two joining partners along a large connection surface. This creates a particularly strong welded con- nection.

In a preferred embodiment, it is provided that the two joining partners are held together at an angle of 5° to 20° in the area of the joint.

The laser beam is focused on the fillet formed by the two joining partners contacting one another, wherein the center of the laser beam is preferably directed at the joint of the first joining partner. The joint, i.e. the area in which the two joining partners adjoin one another, is heated using a beam section of the laser beam spaced apart from the geometric center.

The two joining partners are typically held in a clamping device under pre-tension for the purpose of joining.

It is particularly preferably provided that the laser energy and the contact surface between joining zone and joining flange are configured in relation to one another such that a typically bulging weld seam is provided on the side facing away from the side to which the laser is applied. A weld seam having a convex surface is thus provided, which sufficiently fills the gap, for example for a subsequent CDC coating, in the area of the gap root.

The method proposed here is advantageously carried out without additional welding additives; this significantly reduces the structural design of the welding machines and the process costs.

The welded joint manufactured in this way can be coated without any problems, for example by means of CDC, i.e., uisng a liquid that is relatively highly viscous in the treated state. Such coatings are particularly durable. Such a coating follows the method described above. Advantageously, a zinc coating, which protects the joining partners on the side facing away from the laser application, is not damaged as much as possible in the method described above, so that a CDC coating would ultimately only have to be applied locally.

However, the entire component is typically CDC coated.

The invention is explained in more detail hereinafter with reference to the appended figures. In the figures:

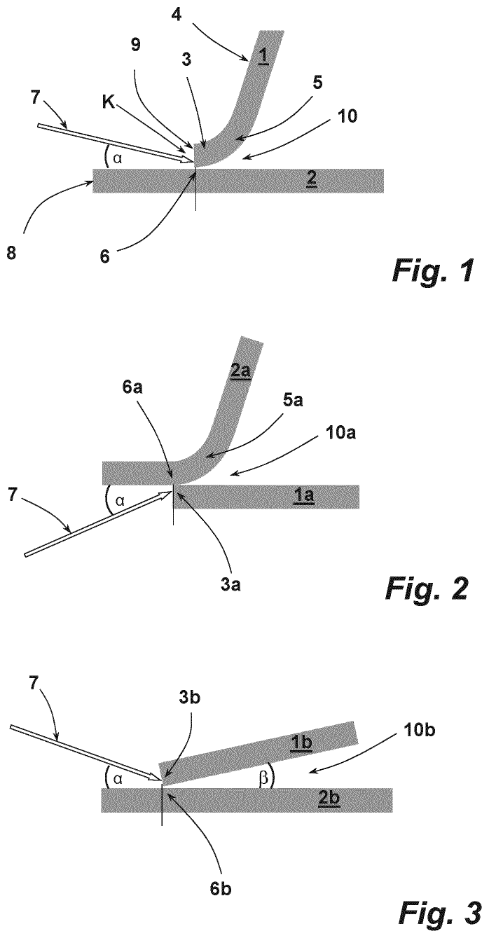

FIG. 1: shows a schematic representation of two joining partners according to a first embodiment,

FIG. 2: shows a schematic representation of two joining partners according to a second embodiment,

FIG. 3: shows a schematic representation of two joining partners according to a third embodiment,

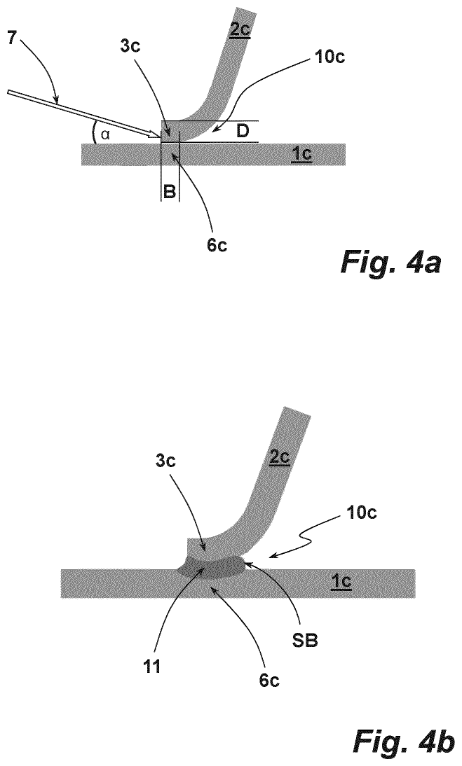

FIG. 4a: shows a schematic representation of two joining partners according to a fourth embodiment,

FIG. 4b: shows the two joining partners of FIG. 4a after performing a laser welding process, and

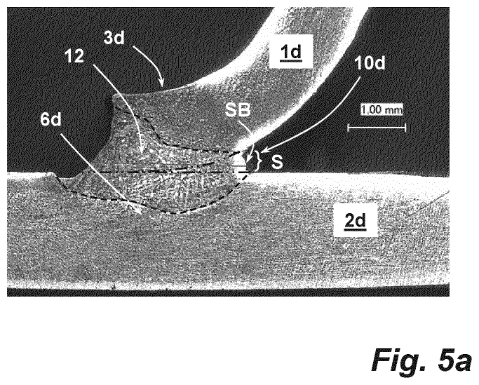

FIG. 5a: shows a microscopic section through the joint of two joining partners joined together, joined using laser welding according to the invention.

FIG. 1 shows a cross section of an arrangement of the edge sections of a first joining partner 1 and a second joining partner 2 according to a first embodiment. The first joining partner 1 comprises a joining flange 3 which is offset or angled in relation to the material 4 delimiting the joint. The transition between the joining flange 3 and the surrounding material 4 is implemented by a curve 5. The second joining partner 2 comprises a joining zone 6. A laser beam is designated by reference number 7.

The side of the joining zone 6 facing toward the laser beam 7 is spaced apart from the end 8—the joint—of this joining partner 2; in this exemplary embodiment, approximately four times the sheet metal thickness of the thinner joining partner, wherein both joining partners 1, 2 are of equal thickness in the present exemplary embodiment.

By arranging the joining flange 3 of the joining partner 1 on the joining zone 6 of the second joining partner 2 formed by a flat side, a stepped arrangement—a fillet K—is formed. The laser beam 7 is focused on the fillet K, which is formed by the joint 9 of the joining flange 3 and the joining zone 6. The angle α between the joining zone 6 and the laser beam 7 is approximately 25° in the exemplary embodiment shown. The center of the laser beam 7 is incident on the lower third of the joint 9 of the first joining partner 1.

In the exemplary embodiment shown, the joining flange 3 contacts the joining zone 6 in line contact.

On the side of the arrangement facing away from the laser beam 7 there is a gap 10 which, due to the curvature of the joining flange 3 in relation to the joining zone 6, expands as the opening angle increases.

FIG. 2 shows a cross section of a second embodiment. In contrast to the first exemplary embodiment, in this exemplary embodiment the first joining partner 1a is straight, while the second joining partner 2a has a joining zone 6a which is provided with a curvature 5a and is therefore curved in sections. In this exemplary embodiment as well, the joining flange 3a of the joining partner 1a and the joining zone 6a of the second joining partner 2a touch in a line.

FIG. 3 shows a cross-sectional representation of a further arrangement according to the invention. Here the joining flange 3b of the first joining partner 1b, which is straight in this exemplary embodiment, is arranged at an angle relative to the joining zone 6b of the second joining partner 2b, which is also straight, at an angle β of approximately 25°. The joining flange 3b also touches the joining zone 6b in a linear manner here.

FIG. 4a shows a cross section of a further embodiment. In this embodiment, the joining flange 3c of the first joining partner 1c contacts the joining zone 6c of the second joining partner 2c in a planar manner. This cross section clearly shows that the planar contact in the direction transverse to the side facing toward the laser beam 7c corresponds approximately to the thickness D of the thinner, in this example the joining flange 3c of the first joining partner 1c, in the width direction B.

FIG. 4b shows the arrangement according to FIG. 4a after the laser welding pro- cess has been completed. It can be seen in this schematic representation that the weld seam has formed along the contact surface of the two joining partners 1c, 2c and has thus connected the two joining partners 1c and 2c via the joining flange 3c or the joining zone 6c. The melt is identified by the reference line 11. It is apparent that the weld seam is curved toward the first joining partner 1c, due to the gap 10c widening in the direction toward the first joining partner 1c.

In this way, the gap 10c arranged on the side facing away from the laser beam 7d can be filled to such an extent that the gap width S is greater than/equal to 0.2 mm and has thus been filled up to this minimum width. As a result of the molten metal penetrating into the gap 10c, a gap base SB has formed, by which the gap width S is limited in the region of its termination pointing towards the melt 11. The remaining minimum gap width S is selected in such a way that an anti-corrosion coating, such as a CDC coating, can easily be introduced into the gap up to its gap base SB formed by the melt. Thus, no non-coat- able spandrels remain in the gap 10c.

FIG. 5a shows a microscopic representation of an example of two joining partners 1d, 2d welded according to the invention. The welding was performed using a laser beam having a diameter of approximately 0.8 mm. The first joining partner 1d is 1.5 mm thick and the second joining partner 2d is 2 mm thick. It can be clearly seen how the weld seam 12 has formed along the contact surface between the joining flange 3d and the joining zone 6d. On the side facing away from the laser application, a bulging, convex weld seam forming the gap base SB is formed.

It can also be seen that parts of the joining flange 3d on the joint side have melted away. It is apparent that only as much material is melted as is required for the joint connection of the two joining partners 1d, 2d, including the desired gap root filling for forming the gap base SB. This material represents the material introduced into the gap 10d by the joint. In this exemplary embodiment, the gap width S is again 0.4 mm.

In FIG. 5a, the boundary of the weld seam 12, i.e., that area which has been melted, is indicated by a dashed line. The original surface of the two joining partners 1d, 2d in the area of the joining point is plotted in this figure using a dot-dash line. It can be clearly seen that material melted by the laser welding method described has flowed into the gap 10d, by which material the minimum width of the gap 10d has been brought to the width of the gap base SB having the gap width S. The curved course of the weld seam 12 can also be seen, as is also shown schematically in FIG. 4b.

The invention has been described on the basis of exemplary embodiments. Numerous further embodiments without departing from the scope of the invention set out in the claims are apparent to a person skilled in the art, without these having to be explained in the context of these explanations.

### LIST OF REFERENCE NUMERALS

Letters appended to reference numerals indicate the same part in a different embodiment.
1 first joining partner
2 second joining partner
3 joining flange
4 surrounding material
5 curvature
6 joining zone
7 laser beam
8 end
9 joint
10 gap
11 weld
12 weld seam
K fillet
D material thickness
B width
S gap width
SB gap base
β angle of joining partner
α angle of laser beam

1. A method for laser welding two joining partners (1, 2; 1a, 2a; 1b, 2b; 1c, 2c; 1d, 2d) made of a metal material and held together in a lap joint, characterized in that the first joining partner (1, 1a, 1b, 1c, 1d) includes a joining flange (3, 3a, 3b, 3c, 3d) having a joint (9) and the second joining partner (2, 2a, 2b, 2c, 2d) includes a joining zone (6, 6a, 6b, 6c, 6d) on a flat side, wherein for the process of laser welding, the first joining partner (1, 1a, 1b, 1c, 1d) is held contacting the joining zone (6, 6a, 6b, 6c, 6d) of the second joining partner (2, 2a, 2b, 2c, 2d) with one side of its joining flange (3, 3a, 3b, 3c, 3d), wherein between the two joining partners (1, 2; 1a, 2a; 1b, 2b; 1c, 2c; 1d, 2d), a gap (10, 10a, 10b, 10c, 10d) widening in the direction pointing away from the side to which the laser is applied is provided and wherein the laser beam (7) is directed in the fillet (K) formed by joining zone (6, 6a, 6b, 6c, 6d) and joining flange (3, 3a, 3b, 3c, 3d) at an angle (α) of 1° to 45° in relation to the plane of the joining zone (6, 6a, 6b, 6c, 6d) and the welding is carried out so that the weld seam (12) formed extends into the gap (10, 10a, 10b, 10c, 10d) and in this way in the gap (10, 10a, 10b, 10c, 10d) a gap base (SB) is formed, by which the opposing surfaces of the joining partners (1, 2; 1a, 2a; 1b, 2b; 1c,, 2c; 1d, 2d) are spaced apart.

2. The method according to claim 1, characterized in that the joining flange (3, 3a, 3b, 3c, 3d) of the first joining partner (1, 1a, 1b, 1c, 1d) is formed and held on the joining zone (6, 6a, 6b, 6c, 6d) of the second joining partner (2, 2a, 2b, 2c, 2d) in such a way that the joining flange (3, 3a, 3b, 3c, 3d) contacts the joining zone (6, 6a, 6b, 6c, 6d) on the side facing toward the laser beam (7) with a line contact or with a surface, the width (B) of which transverse to the side to which the laser is applied corresponds to the material thickness (D) of the thinner joining partner (1, 2; 1a, 2a; 1b, 2b; 1c, 2c; 1d, 2d) in the joining zone (6, 6a, 6b, 6c, 6d).

3. The method according to any one of claim 1 or 2, characterized in that the laser beam is directed into the fillet (K) formed by joining zone and joining flange at an angle (α) of 7° to 30°, preferably 15° to 25°, relative to the plane of the joining zone (6, 6a, 6b, 6c, 6d).

4. The method according to any one of claims 1 to 3, characterized in that the joining flange (3, 3a, 3b, 3c, 3d) is held on the joining zone (6, 6a, 6b, 6c, 6d) at an angle (β) of 5° to 45°.

5. The method according to claim 4, characterized in that the angle (β) is 7° to 30°0 .

6. The method according to any one of claims 1 to 5, characterized in that the joining zone (6, 6a, 6b, 6c, 6d) is at a distance of at least one time, preferably two times the material thickness of the thinner of the two joining partners (1, 2; 1a, 2a; 1b, 2b; 1c, 2c; 1d, 2d) from the end (8) of the second joining partner (2, 2a, 2b, 2c, 2d).

7. The method according to any one of claims 1 to 6, characterized in that at least one joining partner is provided with a zinc coating which vaporizes from the region of the joining zone (6, 6a, 6b, 6c, 6d) during the welding process.

8. The method according to any one of claims 1 to 7, characterized in that a bead- like weld seam is formed in the gap (10, 10a, 10b, 10c, 10d) on the side facing away from the side to which the laser is applied.

9. The method according to any one of claims 1 to 8, characterized in that the welding process is carried out without welding additives.

10. The method according to any one of claims 1 to 9, characterized in that after the welding process the joining partners (1, 2; 1a, 2a; 1b, 2b; 1c, 2c; 1d, 2d) are provided with an anti-corrosion layer, preferably a CDC coating.
